(19) United States
(12) Patent Application Publication
(10) Pub. No.: US 2010/0016024 A1
(43) Pub. Date: Jan. 21, 2010

(54) Mobile Communications Device Diversity Antenna

(76) Inventors: Guangli Yang, Middle Island, NY (US); Hongwei Liu, South Elgin, IL (US); Junsheng Zhao, Vernon Hills, IL (US); Adrian Napoles, Lake Villa, IL (US)

Correspondence Address: MOTOROLA, INC., 1303 EAST ALGONQUIN ROAD, IL01/3RD, SCHAUMBURG, IL, 60196, US

(21) Appl. No.: 12/176,669

(22) Filed: Jul. 21, 2008

(51) Int. Cl. H04B 1/38

(52) U.S. Cl. 455/566; 455/575.1

(57) ABSTRACT

A device including a battery, a wireless transceiver, and a battery cover. The battery cover is adapted to retain the battery in a desired position. The battery cover is further adapted to act as a first antenna in communication with the wireless transceiver for sending and receiving signals in a first frequency band.

### BACKGROUND

Many mobile communications devices use multiple diversity antennas in order to provide performance beyond that achievable with a single antenna. Designers may typically wish to minimize the overall size of such devices in order to increase their portability, and thus the desirability to users. Thus, it is especially important to minimize the space occupied by antennas in devices using multiple antennas.

### SUMMARY OF THE INVENTION

The present application relates to a device comprising a battery, a wireless transceiver, and a battery cover. The battery cover is adapted to retain the battery in a desired position, and is further adapted to act as a first antenna in communication with the wireless transceiver for sending and receiving signals in a first frequency band.

The present application further relates to a device comprising a battery, a means for providing wireless communications, and an antenna means for conducting wireless signals to the means for providing wireless communications. The antenna means is further adapted to retain the battery in a desired position.

### BRIEF DESCRIPTION OF THE DRAWINGS

FIGS. 1a and 1b show an exemplary mobile communications device for implementing an exemplary diversity antenna according to the present invention.

FIGS. 2a and 2b show an exemplary diversity antenna according to the present invention.

FIGS. 3a and 3b show an exemplary mobile communications device incorporating an exemplary diversity antenna according to the present invention.

### DETAILED DESCRIPTION

The exemplary embodiments of the present invention may be further understood with reference to the following description and the appended drawings, wherein like elements are referred to with the same reference numerals. The exemplary embodiments of the present invention describes mobile communications devices designed to minimize the space occupied by diversity antennas. In the exemplary embodiments, these antennas are integrated with the battery doors of the communications devices.

Increasingly, mobile communications devices (e.g., cellular telephones) require the presence of both 850 band and 1900 band diversity antennas to achieve desirable performance. The incorporation of a 1900 band diversity antenna is fairly simple due to the small size of such an antenna. However, the relatively large size of an 850 band diversity antenna (the quarter wave length of signals in this band in free space is roughly 85 millimeters) results in additional challenges arising from its inclusion in a device. Previous solutions, such as the use of a planar inverted F-type antenna (“PIFA”) or folded inverted conformal antenna (“FICA”) may provide for acceptable signal reception, but are poorly suited to the spatial constraints of mobile communications devices, and especially of clamshell-type mobile telephones.

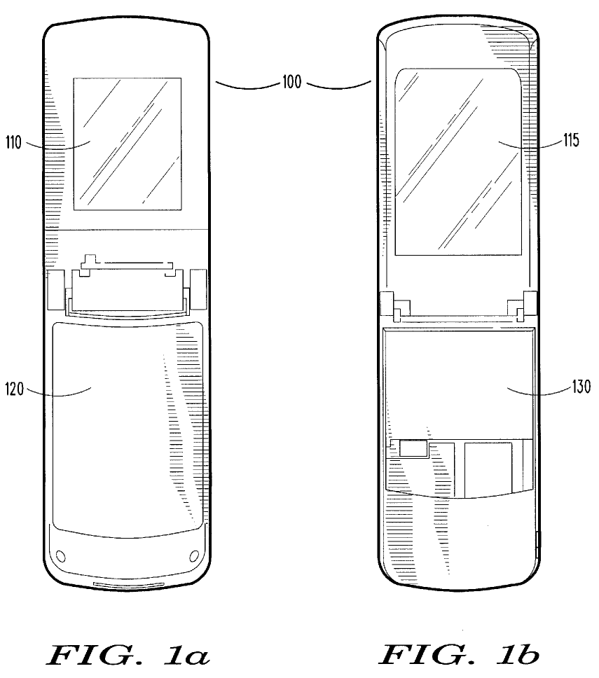

As a result of their large size, integration of an 850 band diversity antenna with existing components of mobile communications devices, rather than including them as additional components, is therefore desirable. The exemplary embodiments of the present invention provide for the use of a removable battery door as an 850 band diversity antenna. FIGS. 1a and 1b illustrate an exemplary mobile communications device 100. In the illustrated embodiment, the device 100 is a clamshell-style mobile telephone; however, in other embodiments, the device 100 may be any of the various other types of devices that require the use of a similarly large antenna but lack sufficient space to provide such an antenna. FIGS. 1a and 1b illustrate the clamshell-style device 100 in the opened position; FIG. 1a shows the front of the device 100 while FIG. 1b shows the same device 100 from the rear. The device 100 includes an interior display 110, an exterior display 115, a keypad 120 and a battery 130 (shown uncovered). Those of skill in the art will understand that this list of components is intended to be exemplary and not all-inclusive.

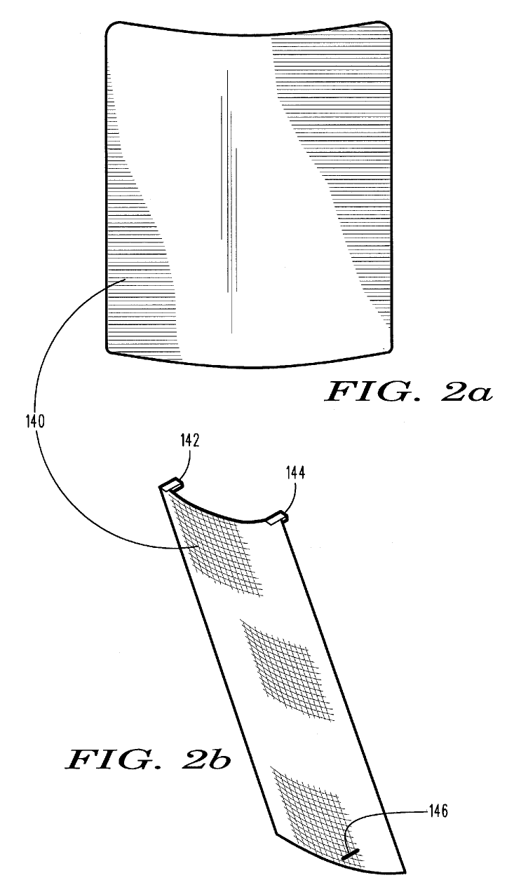

FIGS. 2a and 2b illustrates a battery cover 140 that is adapted to attach to exemplary device 100 in order to retain the battery 130 within the device 100 and hold the battery 130 in its proper location so that electrical contact can be maintained. FIG. 2a shows the battery cover 140 from the rear, while FIG. 2b shows an isometric perspective view. The battery cover 140 may be held in place by a locking mechanism or other retaining means, which may incorporate one or more tabs, latches, hinges, etc., or any other means known in the art. Further, in the exemplary embodiment, the battery cover may serve as an antenna, as will be described in greater detail below.

The battery cover 140 may be constructed from any conducting material such as a metal or other conductor. The battery cover 140 contacts a metal frame (not shown) of the device 100 at two separate grounding points 142 and 144. The grounding points 142 and 144 are used to tune the frequency of the battery cover 140, in its capacity as an antenna, to the desired band using methods that are known in the art. The battery cover 140 also contacts a circuit board (not shown) of the device 100 at a feed point 146, in order to provide for signal transmission from the battery cover 140, also in its capacity as an antenna, to the components of the device that provide for communicative functionality (e.g., a radio transceiver). The feed point 146 may be, for example, a pin, a spring, or some other means that may ensure a steady contact.

In addition to being adapted to affix to the device 100 so as to retain the battery 130, the battery cover 140 is large enough to act as an 850 band diversity antenna, as described above. For example, in this exemplary embodiment, the battery cover 140 is 50 millimeters in width and 56 millimeters in height; the maximum radiation length from the feed point 146 to either of the ground points 142 or 144 is approximately 61 millimeters. For a metal conductor, such as the battery cover 140, surrounded by other components, the quarter wavelength of 850 band signals is on the order of 70 to 75 millimeters, somewhat shorter than the free space quarter wavelength discussed above. While this is longer than the maximum radiation length, the ground points 142 and 144 are used to tune the battery cover 140 to receive signals in the 850 band. However, it is noted that the described locations of the grounding points 142 and 144 and the feed point 146 are only exemplary and that it is possible to move the locations to obtain different lengths for the antenna function of the battery cover 140.

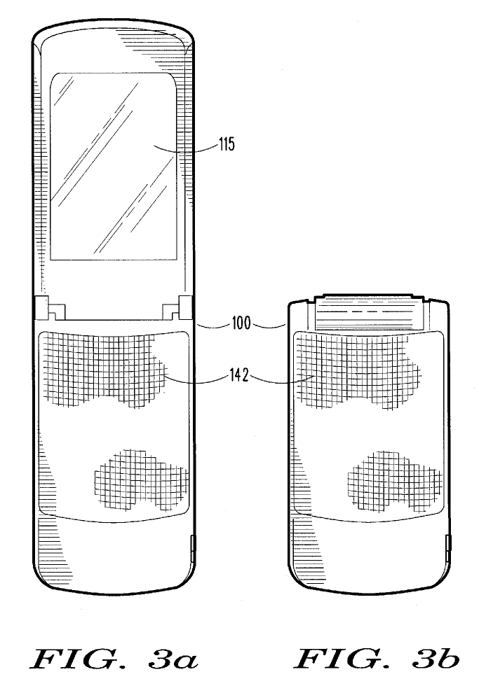

FIG. 3a shows the battery cover 140 attached to the opened device 100; FIG. 3b shows the same device in the closed configuration. As described above, the battery cover 140 restrains the battery 130 (not visible in this figure) in order to insure that the battery 130 does not move during use or when switching between the configurations of FIGS. 3a and 3b, and thereby interrupt the flow of power to other components of the device 100.

By the implementation of the exemplary embodiment, an 850 band diversity antenna may be added to a mobile device without adding size or weight to the device beyond those of existing components. Thus, performance may be maintained in areas where 1900 band signals or similar higher frequency signals may not be properly received.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A device, comprising:
a battery;
a wireless transceiver; and
a battery cover adapted to retain the battery in a desired position, and further adapted to act as a first antenna in communication with the wireless transceiver for sending and receiving signals in a first frequency band.

2. The device of claim 1, wherein the first frequency band is a GSM frequency band.

3. The device of claim 2, wherein the first frequency band is in the range of approximately 869 to 894 MHz

4. The device of claim 1, further comprising a second antenna in communication with the wireless transceiver for sending and receiving signals in a second frequency band.

5. The device of claim 4, wherein the second frequency band is a GSM frequency band.

6. The device of claim 5, wherein the second frequency band is in the range of approximately 1850 to 1990 MHz.

7. The device of claim 1, further comprising one of a display and a keypad.

8. The device of claim 1, wherein the battery cover comprises a grounding point and a feed point.

9. The device of claim 8, wherein the grounding point and the feed point are one of pins and conductive contacts.

10. The device of claim 8, wherein the grounding point is disposed at a first end of the battery cover and the feed point is disposed at a second end of the battery cover.

11. The device of claim 8, wherein a first distance between the grounding point and the feed point is in the range of approximately 55 millimeters to 65 millimeters.

12. The device of claim 8, wherein the battery cover further comprises a further grounding point.

13. The device of claim 1, wherein the battery cover is constructed from a conductive material.

14. The device of claim 13, wherein the conductive material is a metal.

15. A device, comprising:
a battery;
a means for providing wireless communications; and
an antenna means for conducting wireless signals to the means for providing wireless communications, the antenna means being further adapted to retain the battery in a desired position.

16. The device of claim 15, wherein the antenna means is adapted to receive signals in a GSM frequency band.

17. The device of claim 16, wherein the GSM frequency band is in the range of approximately 869 to 894 MHz.

18. The device of claim 15, further comprising a further antenna means for conducting further wireless signals to the means for providing wireless communications.

19. The device of claim 18, wherein the further antenna means is adapted to receive signals in a GSM frequency band.

20. The device of claim 19, wherein the GSM frequency band is in the range of approximately 1850 to 1990 MHz.
